(19) United States
(12) Patent Application Publication
(10) Pub. No.: US 2001/0049794 A1
(43) Pub. Date: Dec. 6, 2001

(54) Write protection software for programmable chip

(76) Inventor: Yu-Guang Chen, Peitou (TW)

Correspondence Address: RABIN & CHAMPAGNE, P.C., 1101 14 Street, N.W., Suite 500, Washington, DC, 20005, US

(21) Appl. No.: 09/861,619

(22) Filed: May 22, 2001

(30) Foreign Application Priority Data
May 24, 2000 (TW) 89110022

(51) Int. Cl. G06F 11/30

(52) U.S. Cl. 713/200; 713/189

(57) ABSTRACT

A software write protection method for protecting the values in the registers of a programmable chip of a computer system. After setting the registers of the programmable chip, the computer system works according to the set function. Any tampering with data inside the register of the programmable chip is not allowed. When virus programs attempt to write erroneous data into the programmable chip, virus commands are changed by the interrupt service program. Hence, unnecessary changes to the values within the register of the programmable chip are prevented leading to a greater stability for the computer system.

### CROSS-REFERENCE TO RELATED APPLICATION

This application claims the priority benefit of Taiwan application serial no. 89110022, filed May 24, 2000.

### BACKGROUND OF THE INVENTION

1. Field of Invention

The present invention relates to the write protection of a programmable chip. More particularly, the present invention relates to a write protection software for preventing the writing of any incorrect data into the register of a programmable chip.

2. Description of Related Art

In the past, most programmable chipsets or ICs have no write protection mechanism. Nowadays, having no write protection is very dangerous because virus program can easily take over the system and insert some incorrect parameters into the programmable chip leading to system failure or instability. Because most consumer electronic products operate as a closed system, there is no need to worry about the infiltration by computer virus. However, for most open type systems, some restriction to accessing and modifying data in the register of programmable chip is important. Only some designated program should be allowed to modify the data within the programmable chip.

FIG. 1 is the architectural layout of a conventional computer system. As shown in FIG. 1, the system includes a central processing unit (CPU) 10, a main memory unit 12, an image accelerator card 14, a northbridge chip 16, a PCI bus 18, a southbridge chip 20 and a peripheral device 22. Northbridge chip 16 is connected to CPU 10, main memory unit 12 and image accelerator card 14. Peripheral device 22 is connected to southbridge chip 20. Northbridge chip 16 and southbridge chip 20 are connected via a PCI bus 18.

On starting the computer system, CPU 10 will look for the address having the first command for booting the system. The start-up address is in the basic input/output system (BIOS) flash memory on a motherboard. After securing the first command, CPU 10 initiates the system start-up program.

The system start-up program inspects all the standard devices (such as the main memory unit 12) to sense their presence. In addition, these devices are checked for any abnormality. Before device inspection, the first 16 field labels of the interrupt vector table are changed to point at the interrupt service routine in the motherboard BIOS. Thereafter, the system start-up program activates mask interrupt. Only after this sequence of steps will the computer respond to external signals such as signals from a keyboard.

In the subsequent step, the system start-up program will check to determine if the interface card includes a BIOS chip. For example, if an image BIOS chip (not shown) is found in image accelerator card 14, the system start-up program will transfer control to the program in the image BIOS chip. Therefore, the image BIOS program can insert the address of interrupt service routine into suitable column in the interrupt vector table. Data can be displayed on a monitor screen when the program in the image BIOS chip is executed. After finishing the execution of the program in the image BIOS chip, control is returned to the system start-up program in the motherboard BIOS.

Similarly, the start-up program on motherboard BIOS is able to set various registers inside the programmable chip (such as northbridge chip 16 and southbridge chip 20) so that connected devices and necessary executions are known to the programmable chip. Subsequently, when CPU 10 needs to access data in main memory unit 12 or peripheral device 22, such operation can be achieved through the preset programmable chip.

The advantages of using a programmable chip in a computer system include the following: (1) The same programmable chip can have a multiplicity of functions to meet various demands by the system. (2) Various parameters inside the registers of programmable chip can be adjusted to operate different types of peripheral devices, for example, a southbridge chip, a disk storage device or a scanner.

However, after the programmable chip is properly set, random changes in internal parameters are undesirable. In other words, the values stored inside the registers of the programmable chip should not be modified freely because changing any parameters inside the registers are likely to affect device connection or operating states. For example, if some of the set parameters inside the registers are changed, transmission errors or execution errors may result leading to system instability when CPU 10 accesses main memory 12 or peripheral device 22.

Most conventional systems use special hardware to prevent any undesirable changes of parameter values inside the registers of a programmable chip. To modify the value in any register within the programmable chip, special register write must be performed repeatedly. The special register write must be performed a definite number of times before the value inside the register can be modified. For example, to modify the value in the third register of the programmable chip, a random value is written into the seventh register repetitively such as five times before writing the modified value into the third register. However, this mode of operation has some disadvantages. When user executes an application program, wrong address may be written due to human errors such as the misuse of the register or the execution of erroneous command. Hence, value in the register of the programmable chip may be modified. Moreover, any engineer familiar with the system can easily write up a virus program. When the virus program infiltrates into the system, the values stored in various registers of the programmable chip may be modified leading to system halt or instability.

In brief, drawbacks of the aforementioned hardware protection method include:

(1) any erroneously use of register or execution errors in an application program may lead to a modification of stored data within the registers of a programmable chip; and

(2) virus program that can modify data within the registers of the programmable chip can be easily written leading to system failure or instability when the program is executed.

### SUMMARY OF THE INVENTION

Accordingly, one object of the present invention is to provide a method that can be applied to a computer system to prevent any stray data from getting into the registers of a programmable chip.

A second object of this invention is to provide software write protection program for the programmable chip in a computer system. The basic input/output system (BIOS) of the computer system contains an interrupt service program and an index table.

To achieve these and other advantages and in accordance with the purpose of the invention, as embodied and broadly described herein, the invention provides a software write protection program for the programmable chip in a computer system. The programmable chip software write protection method provides an interrupt service program. The interrupt service program includes an index table. After the computer system has written index data into the index registers of the programmable chip, the computer system will execute the interrupt service program. The interrupt service program includes the step of determining whether the index data belong to the index table. If the index data belong to the index table, the values in the index registers are changed to non-effective index data.

During the execution of interrupt service program but before the determination of index data belong to the index table or not, data concerning the state of progress of previous program is first stored inside a read/write memory unit. After the termination of the interrupt service program, data concerning the state of progress of previous program is read out from the read/write memory unit. After starting the computer system, index table and the interrupt vector values corresponding to the interrupt service program are read from a read-only-memory unit.

This invention also provides a software write protection method for the programmable chip of a computer system. The computer system includes a programmable chip and an index table that corresponds to the programmable chip. The programmable chip includes a plurality of index registers. The programmable software write protection method provides an interrupt service program. When the computer system has written index data into the index register of the programmable chip, the computer system will execute the interrupt service program. Address values recorded by the index table includes the not-to-be-freely-modified address values of the registers, the address values of interrupt vector, the initial address of the interrupt service program and the address values of the index table.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is the architectural layout of a conventional computer system;

FIG. 2 is a flow chart showing the steps for building an index table and an interrupt service program according to this invention;

FIG. 3 is a flow chart showing the step of reading the values of interrupt vector when a computer system is switched on according to this invention; and

FIG. 4 is a flow chart showing the steps through which the interrupt service program is executed according to this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

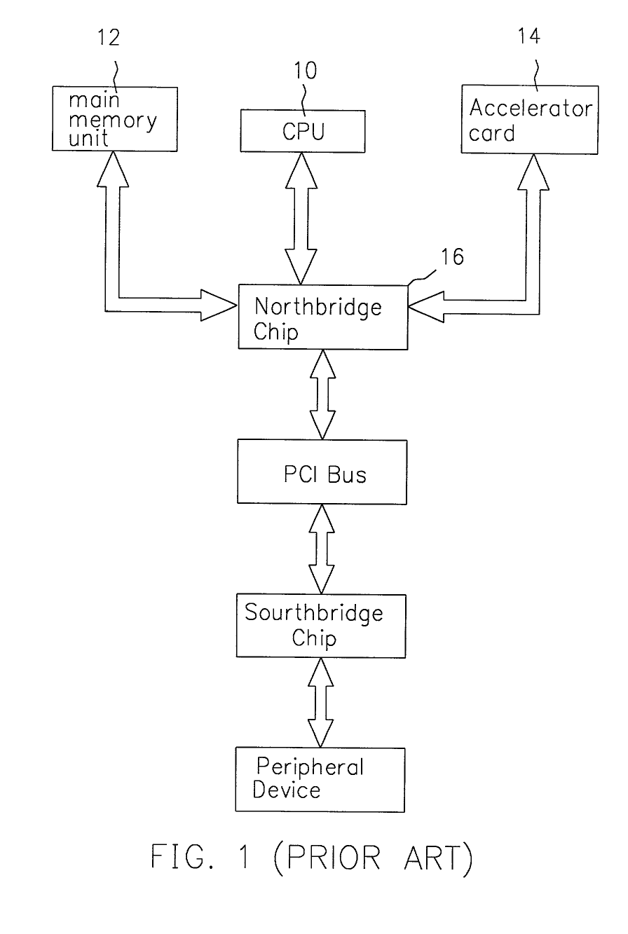

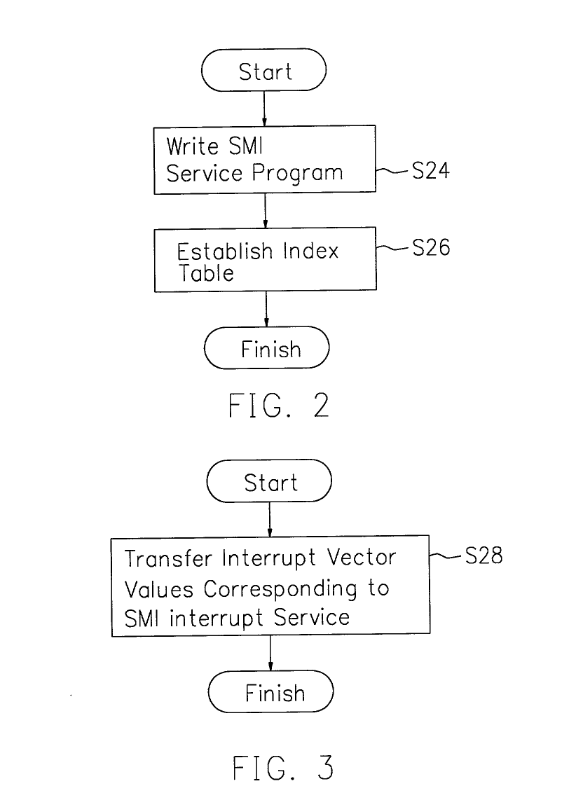

The programmable chip software write protection method of this invention is applied to a computer system such as the one shown in FIG. 1. FIG. 2 is a flow chart showing the steps for building an index table and an interrupt service program according to this invention. Before a computer is shipped out from a manufacturing plant, a system management interrupt service program and other system set-up programs, including the program for setting the I/O addresses that trigger SMI and the program for accessing index addresses of programmable chip, are written into the basic input/output system (BIOS) of the computer system as shown in step S24. Interrupt vector values are placed in suitable fields of the interrupt vector table. The interrupt vector values correspond to the starting address of the SMI service program. An index table is also established in the interrupt service program as shown in step S26. The index data in the index table record the not-to-be-freely-modified address values of the registers, the address values of the interrupt vector, the address values of the interrupt service program and the address values of the index table.

FIG. 3 is a flow chart showing the step of reading the values of interrupt vector when a computer system is switched on according to this invention. On starting the computer system, the computer picks up program data from BIOS in the read-only-memory unit. According to the program, routine operations such as system inspection, loading of interrupt vector table into memory and setting of various chips are conducted. At the same time, the interrupt vector values corresponding to SMI interrupt service program is transferred to the memory in step S28. As an example, for the group state registers in programmable chip that cannot be modified, the stored values in the group state registers provide various functions in the programmable chip. Hence, after the completion of various programmable chip functions at system start-up, the values inside the group state registers should not be modified haphazardly. Therefore, an index table is established to record the addresses of these not-to-be-freely-modified group state registers in the programmable chip so that the CPU know if any index register belongs to one of the not-to-be-freely-modified group state registers.

After the completion of system testing and setting on system start-up, the computer will execute user supplied application programs to their completion. The method of this invention is able to prevent the values inside the group state registers of the programmable chip from changing due to operational errors or infiltration of virus programs. Hence, system failure or instability can be avoided.

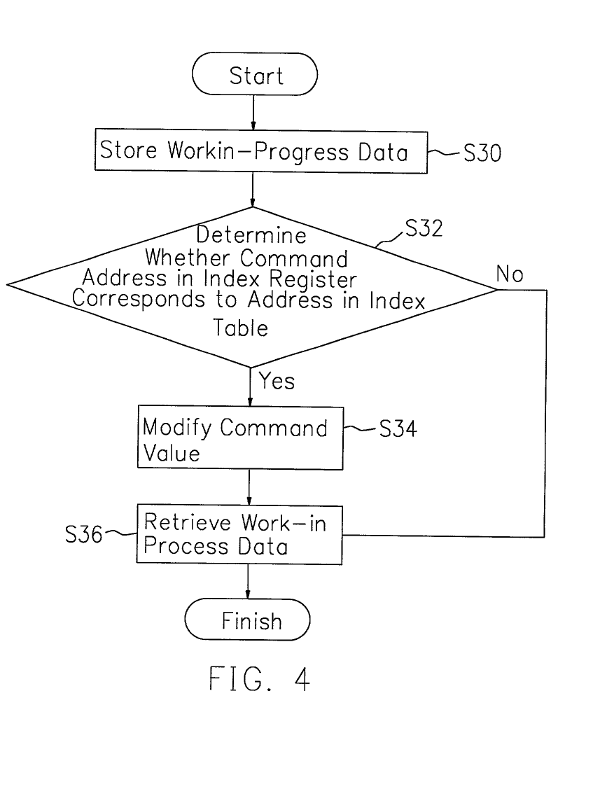

FIG. 4 is a flow chart showing the steps through which the interrupt service program is executed according to this invention. When a CPU executing an application program encounters an index register command earlier written into the programmable chip, the CPU will terminate the current command. An interrupt vector value is lookup from the interrupt vector table. This interrupt vector value corresponds to the initial address of the SMI service program. After finding the interrupt vector value, the CPU will begin to execute the SMI service program.

As shown in FIG. 4, the CPU stores up the work-in-progress data in step S30. The CPU then determines if the command address written into the index register of the programmable chip index register corresponds to the address in the index table in step S32. In other words, whether the address written into the index register corresponds to any address of the group state registers of the programmable chip is determined. If the result is negative, data of work-in-progress are retrieved and SMI service program is terminated followed by the continuation of unfinished current operations in step S36. On the other hand, if there is a correspondence between the address written into the index register and any address of the group state registers of the programmable chip, command value is modified in step S34. The modified value can enable the address in the index register of the programmable chip to point at an address in the read-only-memory unit or an address in memory that does not affect normal operation of the system. Ultimately, the modified value is no longer one of the addresses in the group state registers of the programmable chip. After modification of value, work-in-progress data is retrieved and SMI service program is terminated followed by the continuation of unfinished operations in step S36.

In summary, this invention utilizes a software program to prevent the modification of values in the group state registers of a programmable chip. Since a small software program is all that is required, hardware design problems are eliminated.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A software write protection method for protecting data in the basic input/output system (BIOS) of a programmable chip in a computer system, comprising the steps of:
writing out an interrupt service program; and
setting up an index table.

2. The method of claim 1, wherein the method further includes the step of setting up interrupt vector values serving as the initial address of the interrupt service program.

3. The method of claim 1, wherein values recorded in the index table includes the address of not-to-be-freely-modified register, the interrupt vector address, the initial address of the interrupt service program and the address of the index table.

4. The method of claim 1, wherein the index table is set up within the interrupt service program.

5. A software write-protection method applicable to a computer system having a programmable chip that includes an index register, wherein the software write protection method provides an interrupt service program, the interrupt service program includes an index table, when the computer system writes index data into the index register of the programmable chip, the computer system executes the interrupt service program, and the interrupt service program includes the following steps:
determining if the index data belongs to the index table; and
changing the value in the index register to a non-harmful index value when the index data belongs to the index table.

6. The method of claim 5, wherein before the step of determining if the index data belongs to the index table but during the execution of interrupt service program, further includes storing work-in-progress data in a read/write memory unit.

7. The method of claim 5, wherein after the step of changing the value in the index register during the execution of interrupt service program, further includes writing back the work-in-progress data from the read/write memory unit to a central processing unit.

8. The method of claim 5, wherein after starting the computer system, index table and interrupt vector values corresponding to the interrupt service program are read from a read-only-memory unit.
